(19) United States
(12) Patent Application Publication
(10) Pub. No.: US 2016/0189073 A1
(43) Pub. Date: Jun. 30, 2016

(54) SALES PIPELINE VISUALIZATION TOOL

(71) Applicant: SugarCRM Inc., Cupertino, CA (US)

(72) Inventors: Charles Godewyn, Phoenix, AZ (US); Ing-Marie Jonsson, Los Gatos, CA (US); Riley McLeod, Sunnyvale, CA (US); Maria Zolotova, Mountain View, CA (US)

(21) Appl. No.: 14/586,695

(22) Filed: Dec. 30, 2014

(51) Int. Cl. G06Q 10/06; G06Q 30/00

(52) U.S. Cl. CPC G06Q 10/06316; G06Q 30/01

(57) ABSTRACT

A method, system and computer program product for sales pipeline visualization in a customer relationship management (CRM) system is provided. The method includes defining a desired sales pipeline, the desired sales pipeline comprising different sales stages of a sales process and a number of sales opportunities at each of the different sales stages over a sales cycle. The method also includes generating in a display, a visualization of the desired sales pipeline. The method yet further includes determining an actual number of sales opportunities for an actual sales pipeline for a sales representative utilizing the CRM application at each stage of the sales process over the sales cycle and additionally generating in the display a visualization of the actual sales pipeline. Finally, the method includes displaying the additionally generated visualization of the actual sales pipeline in connection with the display of the generated visualization of the desired pipeline.

### BACKGROUND OF THE INVENTION

1. Field of the Invention

The present invention relates to customer relationship management (CRM) and more particularly to sales pipeline management in a CRM application.

2. Description of the Related Art

A sales pipeline describes an approach to selling, founded upon the underlying principle of a sales process. A sales process includes the individual steps sales professionals perform from the initial contact with a potential customer, or prospect, to qualifying that prospect into a lead, and further validating that lead into a sales opportunity followed through the different stages until closed. The sales pipeline represents all sales opportunities arranged along each of the sales steps that make up the sales process.

A sales pipeline ordinarily is represented by a graphical image—typically a funnel. The funnel shape represents a large number of prospects at an early stage of the sales process. The funnel shape also represents a smaller number of prospects at a later stage of the sales process, the difference in the number of prospects at the early stage and the later stage representative of those prospects that are disqualified at some intermediate stage of the sales process.

Customarily, an effective sales pipeline is visualized to include three times as many prospects as those necessary to meet an annual quota of sales for a sales professional. The enlargement of the sales pipeline to accommodate the annual quote, however, is arbitrary. Further, the rate at which different initial prospects become disqualified from a particular sales process can vary from product to product, service to service and sales organization to sales organization. In fact, the notion of tying the initial size of the size pipeline in turns of a number of initial prospects to an annual quota may be flawed as the sales cycle of the sales pipeline may vary from months to multiple years. Thus, the ideal visualization of a sales pipeline varies from sales organization to sales organization, from sales professional to sales professional.

Monitoring the progress of a sales professional in respect to a sales pipeline oftentimes is a manual process. In this regard, generally the sales professional meets face to face with a sales manager to discuss a number of opportunities in a sales pipeline and the progress experienced in respect to progressing those opportunities towards closing. More sophisticated sales organizations assign probabilities to different stages of the sales process so as to compute with some accuracy any difference between a projected sales volume of a sales professional and a desired sales volume based upon the organizational preferred sales pipeline. However, for the sales professional obtaining an easily recognizable indication of progress in respect to a desired sales pipeline remains elusive.

### BRIEF SUMMARY OF THE INVENTION

Embodiments of the present invention address deficiencies of the art in respect to sales pipeline management and provide a novel and non-obvious method, system and computer program product for sales pipeline visualization in a CRM system. In an embodiment of the invention, a method for sales pipeline visualization in a CRM system, includes defining a desired sales pipeline in a CRM application, the desired sales pipeline comprising multiple different sales stages of a sales process and a number of sales opportunities at each of the different sales stages over a sales cycle. The method also includes generating in a display of the host computing system, a visualization of the desired sales pipeline. The method yet further includes determining an actual number of sales opportunities for an actual sales pipeline for a sales representative utilizing the CRM application at each stage of the sales process over the sales cycle and additionally generating in the display a visualization of the actual sales pipeline. Finally, the method includes displaying the additionally generated visualization of the actual sales pipeline in connection with the display of the generated visualization of the desired pipeline.

In one aspect of the embodiment, the method further includes detecting when the additionally generated visualization of the actual sales pipeline differs from the generated visualization of the desired pipeline by a threshold amount, and in response to the additionally generated visualization of the actual sales pipeline differing from the generated visualization of the desired pipeline by the threshold amount, displaying an alert in a graphical user interface of the CRM application. In another aspect of the embodiment, the method further includes detecting when the additionally generated visualization of the actual sales pipeline differs from the generated visualization of the desired pipeline by a threshold amount, and in response to the additionally generated visualization of the actual sales pipeline differing from the generated visualization of the desired pipeline by the threshold amount, displaying in a graphical user interface of the CRM application a listing of tasks to be performed in connection with business opportunities of the actual sales pipeline. In yet another aspect of the embodiment, the additionally generated visualization of the actual sales pipeline is superimposed over the display of the visualization of the desired pipeline in the display.

In another embodiment of the invention, a CRM data processing system is configured for sales pipeline visualization. The system includes a host computing system that includes one or more computers, each with memory and at least one processor. The system also includes a CRM application executing in the memory of the host computing system. Finally, the system includes a sales pipeline visualization module coupled to the CRM application. The module includes program code enabled upon execution in the memory of the computer to define a desired sales pipeline comprising multiple different sales stages of a sales process and a number of sales opportunities at each of the different sales stages over a sales cycle, to generate in a display of the host computing system, a visualization of the desired sales pipeline, to determine an actual number of sales opportunities for an actual sales pipeline for a sales representative utilizing the CRM application at each stage of the sales process over the sales cycle to additionally generate in the display a visualization of the actual sales pipeline, and to display the additionally generated visualization of the actual sales pipeline in connection with the display of the generated visualization of the desired pipeline.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

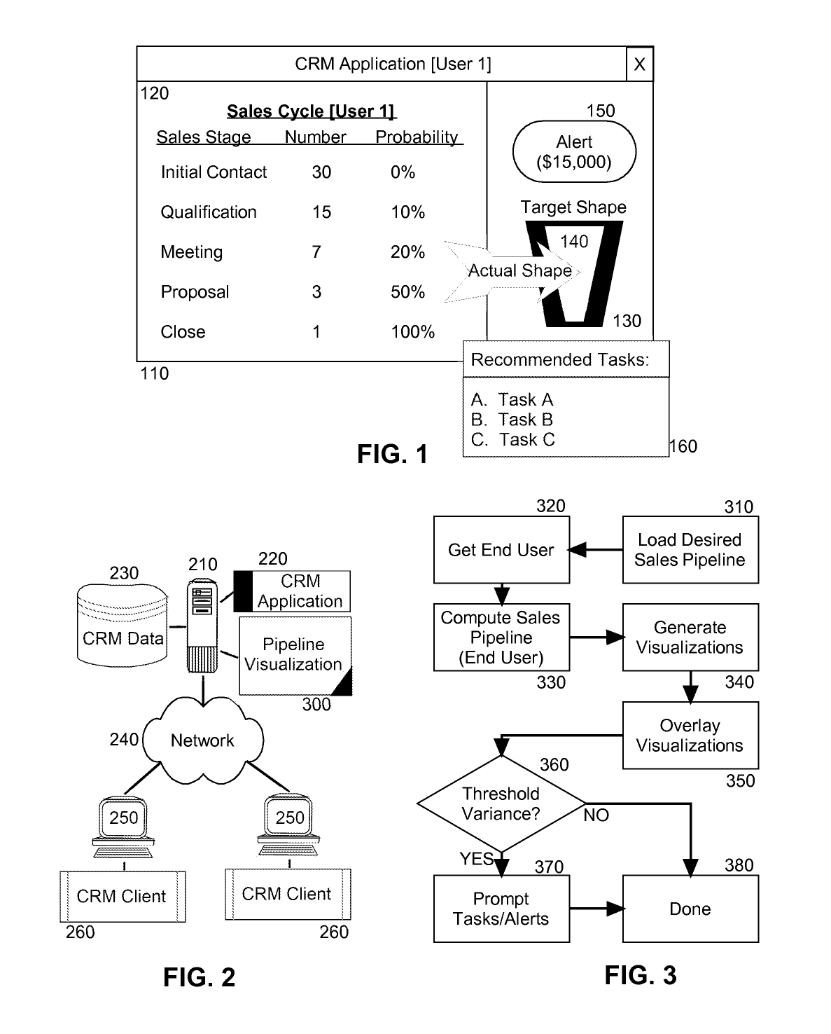

FIG. 1 is a pictorial illustration of a process for sales pipeline visualization in a CRM system;

FIG. 2 is a schematic illustration of a CRM data processing system configured for sales pipeline visualization; and,

FIG. 3 is a flow chart illustrating a process for sales pipeline visualization in a CRM system.

### DETAILED DESCRIPTION OF THE INVENTION

Embodiments of the invention provide for sales pipeline visualization in a CRM system. In accordance with an embodiment of the invention, a desired sales pipeline can be defined. The sales pipeline can include different stages of a sales process over a sales cycle and a number of desired sales opportunities for each of the different stages. A visualization of the desired sales pipeline can be generated in a display of a computer in connection with a CRM application. In addition, actual number of sales opportunities for an actual sales pipeline can be determined for a sales representative utilizing the CRM application at each stage of the sales process over the sales cycle. Consequently, a visualization of the actual sales pipeline can be generated in the display of the computer in connection with the CRM application and superimposed in respect to the visualization of the desired pipeline. In this way, the sales representative can readily ascertain how the sales representative has progressed in respect to a desired sales pipeline.

In further illustration, FIG. 1 pictorially shows a process for sales pipeline visualization in a CRM system. As shown in FIG. 1, a CRM application 110 can include a display of a sales pipeline 120 for different sales stages of a sales process of an end user of the CRM application 110. The sales pipeline 120 can include a specification of each different stage of a sales process, a number of actual sales opportunities recorded in the CRM application 110 for the end user. The sales pipeline 120 further can include a probability of closing each of the sales opportunities at each of the sales stages of the sales process. Of note a visualization 140 of the sale pipeline 120 can be presented in a user interface of the CRM application 110. Further, a visualization 130 of a desired sales pipeline can be presented in connection with the visualization 140. For instance the visualization 140 can be an overlay to the visualization 130.

A comparison of the sales pipeline 120 can be performed in connection with a sales pipeline defined for the visualization 140. To the extent that the sales pipeline 120 deviates by a threshold value from the sales pipeline defined for the visualization 140, an alert 150 can be displayed the user interface to the CRM application 110. The alert can indicate not only that the sales pipeline 120 is not performing in accordance with a desired sales pipeline defined for the visualization 130, but also a revenue value can be computed as a difference between a revenue value of the sales pipeline defined for the visualization 130 and the sales pipeline 120. The computed revenue value in turn can be displayed in connection with the alert. As an alternative, one or more tasks 160 can be presented in the user interface of the CRM application 110 as a suggested as to how to improve the sales pipeline 120.

The process described in connection with FIG. 1 can be implemented in a CRM data processing system. In further illustration, FIG. 2 schematically shows a CRM data processing system configured for sales pipeline visualization. The system can include a host computing system that includes one or more computers, each with memory and at least one processor. The host computing system 210 can support the operation of a CRM application 220 accessing CRM data in a data store 230. One or more client computers 250, that are communicatively coupled to the host computing system 210 over data communications network 240, can support the execution of a CRM client 260 with which the CRM data can be accessed in the data store 230.

Of note, a pipeline visualization module 300 can be coupled to the CRM application 220. The module 300 can include program code that when executed in the memory of the host computing system 210, is enabled to define a sales pipeline including different stages of a sales process over a sales cycle and a number of desired sales opportunities for each of the different stages. The desired sales pipeline can be defined, for example, based upon past sales performance evident from sales data stored in connection with the CRM system. The past sales performance could be, for example, attributable to one or more sales persons of an organization, or for example, attributable to an industrial convention, or simply based upon desired goals.

The program code is further enabled to generate a visualization of the desired sales pipeline in a display of a corresponding one of the client computers 250 in connection with a CRM client 260. The program code yet further is enabled to determine an actual number of sales opportunities for an actual sales pipeline for a sales representative utilizing the CRM application 220 through the CRM client 260 of the corresponding one of the client computer 250 at each stage of the sales process over the sales cycle. Finally, the program code is enabled to generate a visualization of the actual sales pipeline and to superimpose the generated visualization in respect to the generated visualization of the desired pipeline.

In even yet further illustration of the operation of the pipeline visualization module 300, FIG. 3 is a flow chart illustrating a process for sales pipeline visualization in a CRM system. Beginning in block 310, a desired sales pipeline is loaded into memory and an end user is identified in block 320 accessing the CRM application. In block 330, an actual sales pipeline for the end user is computed and in block 340, a visualization is generated for the desired sales pipeline, and also for the actual sales pipeline. Thereafter, in block 350 the visualization for actual sales pipeline is overlain about the visualization for the desired sales pipeline in a user interface for the CRM application.

In decision block 360, it can be determined whether or not the actual sales pipeline varies from the desired sales pipeline by a threshold amount. If so, in block 370 an alert can be generated in the user interface for the CRM application. Optionally, the alert can include a revenue amount attributable to the difference between the actual sales pipeline and the desired pipeline based upon a determined amount of revenue attributable to each business opportunity of each pipeline, and a probability of closing each business opportunity dependent upon a stage of the sales process to which the sales opportunity belongs. As another option, in block 370 one or more recommended tasks can be displayed in a list of tasks in response to a determination that the actual sales pipeline varies from the desired sales pipeline by a threshold amount. Thereafter, the process can end in block 380.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for sales pipeline visualization in a customer relationship management (CRM) system, the method comprising:
defining a desired sales pipeline in a CRM application executing in memory of a host computing system, the desired sales pipeline comprising multiple different sales stages of a sales process and a number of sales opportunities at each of the different sales stages over a sales cycle;
generating in a display of the host computing system, a visualization of the desired sales pipeline;
determining an actual number of sales opportunities for an actual sales pipeline for a sales representative utilizing the CRM application at each stage of the sales process over the sales cycle;
additionally generating in the display a visualization of the actual sales pipeline; and,
displaying the additionally generated visualization of the actual sales pipeline in connection with the display of the generated visualization of the desired pipeline.

2. The method of claim 1, further comprising:
detecting when the additionally generated visualization of the actual sales pipeline differs from the generated visualization of the desired pipeline by a threshold amount; and,
in response to the additionally generated visualization of the actual sales pipeline differing from the generated visualization of the desired pipeline by the threshold amount, displaying an alert in a graphical user interface of the CRM application.

3. The method of claim 1, further comprising:
detecting when the additionally generated visualization of the actual sales pipeline differs from the generated visualization of the desired pipeline by a threshold amount; and,
in response to the additionally generated visualization of the actual sales pipeline differing from the generated visualization of the desired pipeline by the threshold amount, displaying in a graphical user interface of the CRM application a listing of tasks to be performed in connection with business opportunities of the actual sales pipeline.

4. The method of claim 2, wherein the alert includes an amount of revenue representative of a disparity between a value of the desired sales pipeline and a value of the actual sales pipeline

5. The method of claim 1, wherein the additionally generated visualization of the actual sales pipeline is superimposed over the display of the visualization of the desired pipeline in the display.

6. A customer relationship management (CRM) data processing system configured for sales pipeline visualization, the system comprising:
a host computing system comprising one or more computers, each with memory and at least one processor;
a CRM application executing in the memory of the host computing system; and, a sales pipeline visualization module coupled to the CRM application, the module comprising program code enabled upon execution in the memory of the computer to define a desired sales pipeline comprising multiple different sales stages of a sales process and a number of sales opportunities at each of the different sales stages over a sales cycle, to generate in a display of the host computing system, a visualization of the desired sales pipeline, to determine an actual number of sales opportunities for an actual sales pipeline for a sales representative utilizing the CRM application at each stage of the sales process over the sales cycle to additionally generate in the display a visualization of the actual sales pipeline, and to display the additionally generated visualization of the actual sales pipeline in connection with the display of the generated visualization of the desired pipeline.

7. The system of claim 6, wherein the program code is further enabled to:
detect when the additionally generated visualization of the actual sales pipeline differs from the generated visualization of the desired pipeline by a threshold amount; and,
in response to the additionally generated visualization of the actual sales pipeline differing from the generated visualization of the desired pipeline by the threshold amount, to display an alert in a graphical user interface of the CRM application.

8. The system of claim 6, wherein the program code is further enabled to:
detect when the additionally generated visualization of the actual sales pipeline differs from the generated visualization of the desired pipeline by a threshold amount; and,
in response to the additionally generated visualization of the actual sales pipeline differing from the generated visualization of the desired pipeline by the threshold amount, to display in a graphical user interface of the CRM application a listing of tasks to be performed in connection with business opportunities of the actual sales pipeline.

9. The system of claim 7, wherein the alert includes an amount of revenue representative of a disparity between a value of the desired sales pipeline and a value of the actual sales pipeline

10. The system of claim 6, wherein the additionally generated visualization of the actual sales pipeline is superimposed over the display of the visualization of the desired pipeline in the display.

11. A computer program product for sales pipeline visualization in a customer relationship management (CRM) system, the computer program product comprising a computer readable storage medium having program instructions embodied therewith, the program instructions executable by a device to cause the device to perform a method comprising:
defining a desired sales pipeline in a CRM application executing in memory of a host computing system, the desired sales pipeline comprising multiple different sales stages of a sales process and a number of sales opportunities at each of the different sales stages over a sales cycle;
generating in a display of the host computing system, a visualization of the desired sales pipeline;
determining an actual number of sales opportunities for an actual sales pipeline for a sales representative utilizing the CRM application at each stage of the sales process over the sales cycle;
additionally generating in the display a visualization of the actual sales pipeline; and,
displaying the additionally generated visualization of the actual sales pipeline in connection with the display of the generated visualization of the desired pipeline.

12. The computer program product of claim 11, wherein the method further comprises:
detecting when the additionally generated visualization of the actual sales pipeline differs from the generated visualization of the desired pipeline by a threshold amount; and,
in response to the additionally generated visualization of the actual sales pipeline differing from the generated visualization of the desired pipeline by the threshold amount, displaying an alert in a graphical user interface of the CRM application.

13. The computer program product of claim 11, wherein the method further comprises:
detecting when the additionally generated visualization of the actual sales pipeline differs from the generated visualization of the desired pipeline by a threshold amount; and,
in response to the additionally generated visualization of the actual sales pipeline differing from the generated visualization of the desired pipeline by the threshold amount, displaying in a graphical user interface of the CRM application a listing of tasks to be performed in connection with business opportunities of the actual sales pipeline.

14. The computer program product of claim 12, wherein the alert includes an amount of revenue representative of a disparity between a value of the desired sales pipeline and a value of the actual sales pipeline

15. The computer program product of claim 11, wherein the additionally generated visualization of the actual sales pipeline is superimposed over the display of the visualization of the desired pipeline in the display.
